(19) United States
(12) Patent Application Publication
(10) Pub. No.: US 2017/0312791 A1
(43) Pub. Date: Nov. 2, 2017

(54) METHOD AND APPARATUS FOR SUBSTRATE SURFACE CLEANING

(71) Applicant: CORNING INCORPORATED, Corning, NY (US)

(72) Inventors: Chen-Kun Kuo, Tainan City (TW); Chien-Lin Liu, Tainan City (TW); Kuo-Sung Pan, Tainan City (TW)

(21) Appl. No.: 15/528,844

(22) PCT Filed: Nov. 17, 2015
(86) PCT No.: PCT/US15/61007

§ 371 Date: May 23, 2017

Related U.S. Application Data
(60) Provisional application No. 62/083,518, filed on Nov. 24, 2014.

(51) Int. Cl. B08B 3/02; B08B 11/04

(52) U.S. Cl. CPC B08B 3/022; B08B 11/04

(57) ABSTRACT

A method and apparatus for substrate, such as glass substrate, surface cleaning include one or more nozzles to deliver a cleaning fluid to one or more edges of a substrate and a roller that includes a plurality of angled channels on the outer surface of the roller. The roller is configured to contact a surface of the substrate and the angled channels are configured to laterally channel fluid and particles toward opposite axial ends of the roller.

This application claims the benefit of priority under 35 U.S.C. §365 of International Patent Application Serial No. PCT/US15/61007 filed on Nov. 17, 2015, which claims benefit of priority under 35 U.S.C. §119 of U.S. Provisional Application Serial No. 62/083,518 filed on Nov. 24, 2014, the content of each are relied upon and incorporated herein by reference in their entirety.

### BACKGROUND

### Field

The present disclosure relates generally to methods and apparatuses for cleaning at least one edge of a substrate, and in particular to methods and apparatuses for cleaning at least one edge of a glass substrate.

### Technical Background

Consumer demand for high performance display devices, such as liquid crystal and plasma displays, has grown markedly in recent years due to the continually improving display quality, decreased weight and thickness, low power consumption, and increased affordability of these devices. Such high performance display devices can be used to display various kinds of information, such as images, graphics, and text.

High performance display devices typically employ one or more substrates, such as one or more glass substrates. Surface quality requirements for substrates have become increasingly stringent as the demand for improved resolution and image performance continues to increase. For example, higher resolution displays with smaller pixel sizes results in the panel performance being more sensitive to surface particles, adhered glass (ADG), stain, scratch and other abnormalities. Accordingly, customer requirements for these characteristics have become increasingly stringent and, in that regard, it is desirable to produce substrate surfaces with as low of particle densities as possible.

### SUMMARY

In one embodiment, a method for cleaning at least one edge of a substrate includes conveying the at least one substrate edge across a cleaning system. The cleaning system includes at least one nozzle configured to deliver at least one cleaning fluid to at least one edge of the substrate. The cleaning system also includes at least one roller comprising a plurality of angled channels on the outer surface of the roller. The plurality of angled channels are configured to laterally channel fluid and particles toward opposite axial ends of the roller. The substrate includes a first surface and a second surface that is substantially parallel to the first surface and the at least one roller is configured to contact at least one of the first surface and the second surface.

In another embodiment, an apparatus for cleaning at least one edge of a substrate is configured to convey the at least one substrate edge across a cleaning system. The cleaning system includes at least one nozzle configured to deliver at least one cleaning fluid to at least one edge of the substrate. The cleaning system also includes at least one roller comprising a plurality of angled channels on the outer surface of the roller. The plurality of angled channels are configured to laterally channel fluid and particles toward opposite axial ends of the roller. The substrate includes a first surface and a second surface that is substantially parallel to the first surface and the at least one roller is configured to contact at least one of the first surface and the second surface.

Additional features and advantages of these and other embodiments will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description present embodiments of the present disclosure, and are intended to provide an overview or framework for understanding the nature and character of the embodiments as claimed. The accompanying drawings are included to provide a further understanding of these and other embodiments, and are incorporated into and constitute a part of this specification. The drawings illustrate various embodiments of these and other embodiments, and together with the description serve to explain the principles and operations thereof.

### BRIEF DESCRIPTION OF THE DRAWINGS

FIG. 1 is a top view of a roller comprising a plurality of angled channels on the outer surface of the roller according to at least one embodiment disclosed herein;

FIG. 2 is a side cutaway view of a roller comprising a plurality of angled channels on the outer surface of the roller, including an exploded view of one of the channels, according to at least one embodiment disclosed herein;

FIG. 3 is a perspective view of a roller comprising a plurality of angled channels on the outer surface of the roller according to at least one embodiment disclosed herein;

FIG. 4 is a side view of a portion of a cleaning system that includes a plurality of nozzles configured to deliver at least one cleaning fluid to the substrate surfaces and a plurality of rollers that comprise a plurality of angled channels on the outer surfaces of the rollers;

FIG. 5A is a top view of a roller and corresponding side view of the roller and substrate, wherein the roller contacts a first surface of the substrate;

FIG. 5 B is a top view of a roller and corresponding side view of the roller and glass substrate, wherein the roller contacts a second surface of the substrate;

FIG. 5C is a top view of a roller and corresponding side view of the roller and glass substrate, wherein the roller contacts a first surface of the substrate; and

FIG. 5D is a top view of a roller and corresponding side view of the roller and glass substrate, wherein the roller contacts a second surface of the substrate.

### DETAILED DESCRIPTION

Reference will now be made to embodiments of the present disclosure, examples of which are illustrated in the accompanying drawings. Whenever possible, the same reference numerals will be used throughout the drawings to refer to the same or like parts.

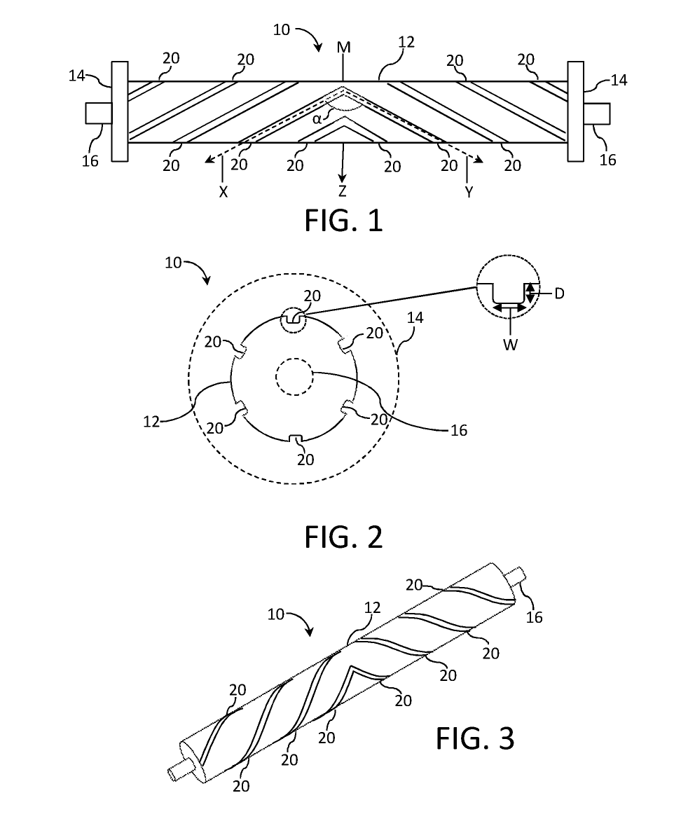

FIG. 1 is a top view of an exemplary roller according to one or more embodiments disclosed herein. Roller 10 includes main roller body 12, collar 14, and axle 16. Main roller body 12 includes a plurality of angled channels 20. Angled channels 20 are configured to laterally channel fluid and particles toward opposite axial ends of the roller.

The main roller body 12 may, in certain embodiments, be comprised of at least one porous sponge or sponge-like material. Such materials include sponges or sponge-like materials comprising polyvinyl acetate, polyvinyl alcohol, nylon, urethane, mohair or any other porous or sponge-like material. The porous sponge or sponge-like material should have properties that provide a high level of absorption capacity while at the same time not causing significant scratches or other defects on the substrate, such as on a glass substrate.

For example, in certain embodiments, the porous sponge or sponge-like material has an average pore size of from 10 microns to 250 microns, such as from 30 microns to 200 microns, and further such as from 50 microns to 150 microns, a porosity of from 50% to 96%, such as from 75% to 93%, and further such as from 80% to 90%, a hardness of from 15 gf/cm² to 250 gf/cm², such as from 30 gf/cm²to 150 gf/cm², and further such as from 50 gf/cm² to 100 gf/cm², a water absorption ratio of from 100% to 1600%, such as from 200% to 1400%, and further such as from 400% to 1200%, and a unit area water absorption rate of from 0.01 ml/s to 0.5 ml/s, such as from 0.02 ml/s to 0.25 ml/s, and further such as from 0.05 ml/s to 0.15 ml/s.

For example, main roller body 12 can comprise sponge material comprising polyvinyl acetate, such as polyvinyl acetate having an average pore size of 100±50 microns, a porosity of 89±1%, a hardness of 75±5 gf/cm², a water absorption ratio of 800±30%, and a unit area water absorption rate of 0.10±0.01 ml/s.

Main roller body 12 may also consist essentially of sponge material comprising polyvinyl acetate, such as polyvinyl acetate having an average pore size of 100±50 microns, a porosity of 89±1%, a hardness of 75±5 gf/cm², a water absorption ratio of 800±30%, and a unit area water absorption rate of 0.10±0.01 ml/s.

Angled channels may, in certain exemplary embodiments, be substantially parallel to each other along at least a portion of their lengths, such as is shown in FIG. 1. As shown in FIG. 1, angled channels 20 may also be mirror images of each other on either side of the main roller body 12 in the axial direction, wherein the angled channels 20 are substantially parallel to each other between the midpoint (M) of the main roller body 12 and each axial end of the main roller body 12, the channels between the midpoint (M) and a first axial end of the main roller body 12 extending tangent to line (X) and the channels between the midpoint (M) and the second axial end of the main roller body 12 extending tangent to line (Y), wherein the mirror angle between (X) and (Y) is indicated by alpha (α). Alternatively stated, a plurality of angled channels 20 may extend from the axial midpoint (M) of the main roller body 12 toward a first axial end of the main roller body 12 while the plurality angled channels 20 also extend from the axial midpoint of the main roller body 12 towards a second axial end of the main roller body 12, wherein the ends of each angled channel are each approximately equally circumferentially offset from the portion of the angled channel extending through the axial midpoint (M).

In certain exemplary embodiments, alpha (α) may range from 60 to 120 degrees, such as from 70 to 110 degrees and further such as from 80 to 100 degrees.

In certain exemplary embodiments, the amount of circumferential offset between the ends of each angled channel and the portion of the angled channel extending through the axial midpoint (M) is at least 60 degrees, such as from 60 degrees to 270 degrees, including from 90 degrees to 180 degrees.

In certain exemplary embodiments, the conveyance direction of the substrate can be represented by arrow (Z) in FIG. 1 and the plurality of angled channels 20 are substantially parallel to each other between the midpoint (M) of the main roller body 12 and each axial end of the main roller body 12, the channels between the midpoint (M) and a first axial end of the main roller body 12 extending tangent to line (X) and the channels between the midpoint (M) and the second axial end of the main roller body 12 extending tangent to line (Y), such that the angle between the conveyance direction (Z) and the channels tangent to line (X) ranges from 30 to 60 degrees and the angle between the conveyance direction (Z) and the channels tangent to line (Y) ranges from 30 to 60 degrees.

FIG. 2 is a side cutaway view of an exemplary roller comprising a plurality of angled channels on the outer surface of the roller, including an exploded view of one of the channels, according to one or more embodiments disclosed herein. Roller 10 includes main roller body 12, collar 14, and axle 16. Main roller body 12 includes a plurality of angled channels 20.

While FIG. 2 shows a side cutaway view of six angled channels 20, the number of angled channels in main roller body is not so limited and may, for example, range from 2 to 100, such as from 3 to 40, and further such as from 4 to 20 when viewed in a side cutaway view such as FIG. 2.

The depth (D) and width (W) of angled channels may be the same or different and can be measured relative to the radius and circumference of the main roller body 12. For example, the channels may each have a depth (D) of from 2 to 20 percent, such as from 3 to 15 percent, and further such as from 4 to 10 percent of the radius of the main roller body 12 and have a width (W) of from 1 to 10 percent, such as from 2 to 8 percent, and further such as from 3 to 6 percent of the circumference of the main roller body 12.

FIG. 3 shows a perspective view of a roller comprising a plurality of angled channels on the outer surface of the roller according to at least one embodiment disclosed herein. Roller 10 includes main roller body 12, axle 16, and plurality of angled channels 20 that are configured to laterally channel fluid and particles toward opposite axial ends of the roller.

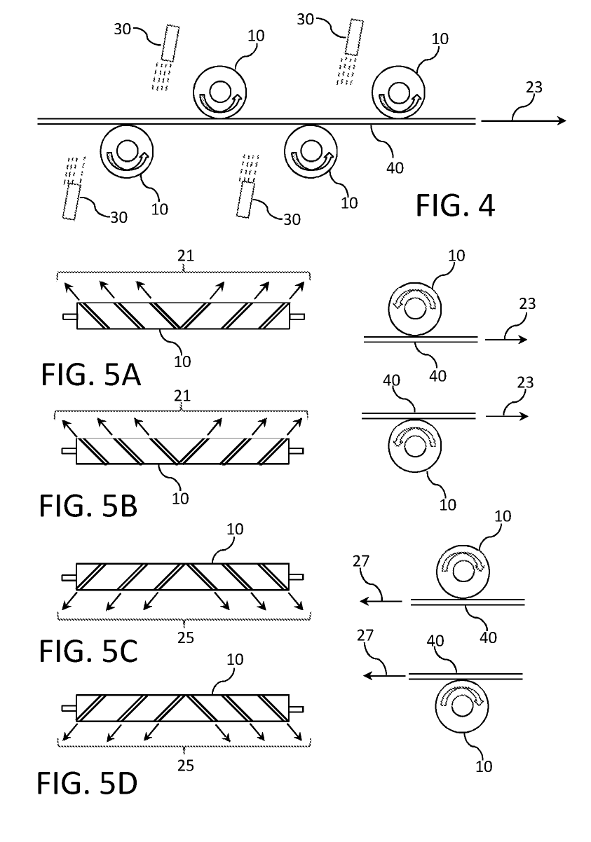

FIG. 4 is a side view of a portion of a cleaning system according to embodiments disclosed herein. Cleaning system includes a plurality of nozzles 30 configured to deliver at least one cleaning fluid to surfaces of a substrate 40 moving in conveyance direction indicated by arrow 23. Cleaning system also includes a plurality of rollers 10 that comprise a plurality of angled channels on the outer surfaces of the rollers. As shown in FIG. 4, each roller 10 is positioned downstream of a corresponding nozzle 30.

The system shown in FIG. 4 can enable cleaning the first surface and the second surface of the substrate 40, wherein two nozzles 30 are configured to deliver at least one cleaning fluid to a first surface of the substrate and two nozzles 30 are configured to deliver at least one cleaning fluid to a second surface of the substrate. In addition, two rollers 10 are each configured to contact a first surface of the substrate and two rollers 10 are each configured to contact a second surface of the substrate. While FIG. 4 shows two rollers and two nozzles on each side of the substrate, it is to be understood that embodiments disclosed herein can include other numbers of rollers and nozzles, such as from 1 to 20 rollers and nozzles on one or both sides of the substrate.

As used herein, the term “cleaning fluid” is intended to denote any fluid suitable for cleaning a substrate edge, such fluids selected from solvents and cleaning fluids. The fluid may, for example, be chosen from water, deionized water, surfactant solutions, detergent solutions, acids, bases, and combinations thereof. In various exemplary embodiments, the bases may have a pH ranging from about 9 to about 13, and may be chosen from, for example, ammonium hydroxide (NH₄OH), tetramethylammonium hydroxide (TMAH), potassium hydroxide (KOH), and sodium hydroxide (NaOH). Suitable acids include, but are not limited to, acids with a pH ranging from about 1 to about 3, such as hydrofluoric acid (HF), hydrochloric acid (HCl), and citric acid. Without wishing to be bound by theory, it is believed that acidic and basic fluids may have increased cleaning efficacy due to the high degree of repulsion between the particles and the substrate. The repulsion is due to positively charged particles in a highly acidic environment or negatively charged particles in a highly basic environment.

The at least one cleaning fluid may, in certain embodiments, be delivered from the at least one nozzle at room temperature and ambient pressure. Alternatively, the nozzle may operate, for example, as a spray jet, delivering the fluid at elevated pressures. In one embodiment, the fluid may be delivered at a pressure ranging from about 0.1 MPa to about 5 MPa, for example, from about 0.1 MPa to about 0.8 MPa, or from about 1 MPa to about 3 MPa. The presence of at least one nozzle delivering the fluid at an elevated pressure may serve to move the particles away from the substrate edge, thereby reducing the potential for contamination of the substrate surface. In yet further embodiments, the at least one fluid may be heated before delivery to the cleaning interface. For example, the at least one fluid may be heated to a temperature ranging from about 20° C. to about 90° C., such as from about 40° C. to about 75° C.

The substrate may be conveyed across the cleaning system at any speed suitable to effectuate cleaning of the substrate surfaces. For instance, the substrate may be conveyed at a speed ranging from about 1 to about 25 meters per minute. In other embodiments, the substrate may be conveyed at a speed ranging from about 3 to about 8 meters per minute, such as from about 6 to about 10 meters per minute, or from about 15 to about 22 meters per minute.

Rollers 10 may rotate at any speed suitable to effectively channel fluid and particles toward opposite axial ends of the roller. For example, the rollers may rotate at speeds ranging from 50 to 2,000 rpm, such as from 100 to 1,000 rpm, and further such as from 200 to 600 rpm, including from 300 to 500 rpm. Roller speed may also be a function of the size (e.g., width and/or length) of the substrate. For example, higher roller speeds may be used with smaller substrates and vice versa.

At the point where each roller contacts the surface of the substrate, the length or degree of contact between the rollers and the substrate may be the same or may vary between rollers and may differ on different sides of the substrate. For example, the contact length between the rollers and the substrate may range from 0.1 millimeters to 5 millimeters, such as from 0.2 to 2 millimeters, and further such as from 0.5 millimeters to 1 millimeters. In certain exemplary embodiments the contact length between the rollers and a first surface of the substrate (i.e., the upper side of the substrate as shown in FIG. 4) maybe, on average, greater than the contact length between the rollers and a second surface of the substrate (i.e., the lower side of the substrate as shown in FIG. 4). For example, the average contact length between the rollers and a first surface of the substrate can be from 0.5 to 1.5 millimeters when the average contact length between the rollers and a second surface of the substrate is from 0.1 to 0.4 millimeters.

In the embodiment shown in FIG. 4, rollers 10 contact a first surface of the substrate 40 (i.e., the upper side of the substrate as shown in FIG. 4) at a point where the conveyance direction of the substrate 23 is the same as a rotational direction of the rollers. In that embodiment, rollers 10 contact a second surface of the substrate 40 (i.e., the lower side of the substrate as shown in FIG. 4) at a point where the conveyance direction of the substrate 23 is the opposite of the rotational direction of the rollers.

In certain exemplary embodiments, the substrate comprises glass.

In certain exemplary embodiments, the substrate consists essentially of glass.

In certain exemplary embodiments, the substrate comprises a plane of essentially flat glass.

In certain exemplary embodiments, the substrate consists essentially of a plane of essentially flat glass.

In certain exemplary embodiments, the substrate comprises flexible glass.

In certain exemplary embodiments, the substrate consists essentially of flexible glass.

In certain exemplary embodiments, the substrate comprises a glass composition manufactured by a glass manufacturing process selected from the group consisting of the fusion draw process, the float process, and the slot draw process.

In certain exemplary embodiments, the substrate comprises an alkali-free glass comprising in mole percent on an oxide basis: SiO₂: 64.0-71.0; Al₂O₃: 9.0-12.0; B₂O₃:7.0-12.0; MgO: 1.0-3.0; CaO: 6.0-11.5; SrO: 0-2.0; BaO: 0-0.1; wherein: 1.00≦Σ[RO]/[Al₂O₃]≦1.25, where [Al₂O₃] is the mole percent of Al₂O₃ and Σ[RO] equals the sum of the mole percents of MgO, CaO, SrO, and BaO; and the glass has at least one of the following compositional characteristics: (i) on an oxide basis, the glass comprises at most 0.05 mole percent Sb₂O₃; (ii) on an oxide basis, the glass comprises at least 0.01 mole percent SnO₂. Examples of such glass compositions are disclosed in WO2007/002865, the entire disclosure of which is incorporated herein by reference.

In certain exemplary embodiments, the substrate comprises an alkali-free glass comprising in mole percent on an oxide basis: SiO₂: 64.0-72.0; Al₂O₃: 9.0-16.0; B₂O: 1.0-5.0; MgO+La₂O₃: 1.0-7.5; CaO: 2.0-7.5; SrO: 0.0-4.5; BaO: 1.0-7.0; wherein Σ(MgO+CaO+SrO+BaO+3La₂O₃)/(Al₂O₃)≧1.15, where Al₂O₃, MgO, CaO, SrO, BaO, and La₂O₃ represent the mole percents of the respective oxide components. Examples of such glass compositions are disclosed in WO2007/095115, the entire disclosure of which is incorporated herein by reference.

In certain exemplary embodiments, the substrate comprises a glass comprising: 67≦SiO₂≦70; 11≦Al₂O₃<13.5; 3≦B₂O₃≦6; 3.5≦MgO≦7; 4≦CaO ≦7; 1≦SrO≦4; 0≦BaO≦3; 0.02≦SnO₂≦0.3; 0≦CeO₂≦0.3; 0.00≦As₂O₃≦0.5; 0.00≦Sb₂O₃≦0.5; 0.01≦Fe₂O₃≦0.08; F+Cl+Br≦0.4; wherein all oxides are in mol % and 1.05≦(MgO+BaO+CaO+SrO)/Al₂O₃≦1.25; 0.7≦(CaO+SrO+BaO)/Al₂O₃≦0.9; and 0.3≦MgO/(CaO+SrO+BaO)≦0.6, where Al₂O₃, MgO, CaO, SrO and BaO represent the mol percents of the representative oxide components. Examples of such glass compositions are disclosed in U.S. Pat. No. 8,598,056, the entire disclosure of which is incorporated herein by reference.

In certain exemplary embodiments, the substrate comprises an alkali-free glass having a liquidus viscosity of greater than or equal to about 90,000 poises, the glass comprising SiO₂, Al₂O₃, B₂O₃, MgO, CaO, and SrO such that, in mole percent on an oxide basis: 64≦SiO₂≦68.2; 11≦Al₂O₃≦13.5; 5≦B₂O₃≦9; 2≦MgO≦9; 3≦CaO≦9; and 1≦SrO≦5. Examples of such glass compositions are disclosed in U.S. Pat. No. 8,598,055, the entire disclosure of which is incorporated herein by reference.

In certain exemplary embodiments, the substrate comprises a glass exhibiting the following performance criteria: A: Compaction in the LTTC (Low Temperature Test Cycle) less than or equal to 5.5 ppm; B: Compaction in the HTTC (High Temperature Test Cycle) less than or equal to 40 ppm; and C: Less than 50% of an induced stress relaxed in the SRTC (Stress Relaxation Test Cycle), including a glass comprising, in mole percent on an oxide basis: SiO₂ 50-85, Al₂O₃ 0-20, B₂O₃ 0-10, MgO 0-20, CaO 0-20, SrO 0-20, BaO 0-20, where SiO₂, Al₂O₃, B₂O₃, MgO, CaO, SrO and BaO represent the mole percents of the oxide components. Examples of such glass compositions are disclosed in U.S. patent publication no. 2014/0179510, the entire disclosure of which is incorporated herein by reference.

In certain exemplary embodiments, the substrate comprises a substantially alkali-free glass comprising in mole percent on an oxide basis: SiO₂: 65-70.3; Al₂O₃: 11-14; B₂O₃: 2-7.5; MgO: 2-7.5; CaO: 3-11; SrO: 0-5.5; BaO: 0-2; ZnO: 0-2; wherein: (a) [SiO₂]+[Al₂O₃]≦81.3; and (b) Σ[RO]/[Al₂O₃]≦1.3; where [SiO₂] and [Al₂O₃] are the mole percents of SiO₂ and Al₂O₃, respectively, and Σ[RO] equals the sum of the mole percents of MgO, CaO, SrO, BaO, and ZnO. Examples of such glass compositions are disclosed in U.S. application Ser. No. 14/204,456, the entire disclosure of which is incorporated herein by reference.

FIGS. 5A-5D show various top views of a roller and corresponding side views of the roller and substrate, wherein the roller contacts either first or second surface of the substrate and the substrate conveyance direction varies from left to right to right to left. In particular, FIG. 5A shows a top view of a roller 10 and corresponding side view of the roller 10 and substrate 40, wherein the roller contacts a first surface of the substrate and the conveyance direction of the substrate is from left to right, as shown by arrow 23. As can be seen from FIG. 5A, the roller 10 contacts a first surface of the substrate 40 at a point where the conveyance direction of the substrate is the same (left to right) as a rotational direction of the roller 10. In addition, the roller 10 contacts the first surface of the substrate 40 at a point where the plurality of angled channels on the outer surface of the roller 10 extend toward opposite axial ends of the roller while extending in the opposite direction of the conveyance direction of the substrate. Plurality of angled channels laterally channel fluid and particles toward opposite axial ends of the roller as shown by arrows 21.

FIG. 5B shows a top view of a roller 10 and corresponding side view of the roller 10 and substrate 40, wherein the roller contacts a second surface of the substrate and the conveyance direction of the substrate is from left to right, as shown by arrow 23. As can be seen from FIG. 5B, the roller 10 contacts a first surface of the substrate 40 at a point where the conveyance direction of the substrate is the opposite (left to right) as a rotational direction of the roller 10. In addition, the roller 10 contacts the first surface of the substrate 40 at a point where the plurality of angled channels on the outer surface of the roller 10 extend toward opposite axial ends of the roller while extending in the same direction as the conveyance direction of the substrate. Plurality of angled channels laterally channel fluid and particles toward opposite axial ends of the roller as shown by arrows 21. The embodiment shown in FIG. 5B can be used in conjunction with the embodiment shown in FIG. 5A.

FIG. 5C shows a top view of a roller 10 and corresponding side view of the roller 10 and substrate 40, wherein the roller contacts a first surface of the substrate and the conveyance direction of the substrate is from right to left, as shown by arrow 27. As can be seen from FIG. 5C, the roller 10 contacts a first surface of the substrate 40 at a point where the conveyance direction of the substrate is the same (right to left) as a rotational direction of the roller 10. In addition, the roller 10 contacts the first surface of the substrate 40 at a point where the plurality of angled channels on the outer surface of the roller 10 extend toward opposite axial ends of the roller while extending in the opposite direction of the conveyance direction of the substrate. Plurality of angled channels laterally channel fluid and particles toward opposite axial ends of the roller as shown by arrows 25.

FIG. 5D shows a top view of a roller 10 and corresponding side view of the roller 10 and substrate 40, wherein the roller contacts a second surface of the substrate and the conveyance direction of the substrate is from right to left, as shown by arrow 27. As can be seen from FIG. 5D, the roller 10 contacts a first surface of the substrate 40 at a point where the conveyance direction of the substrate is the opposite (right to left) as a rotational direction of the roller 10. In addition, the roller 10 contacts the first surface of the substrate 40 at a point where the plurality of angled channels on the outer surface of the roller 10 extend toward opposite axial ends of the roller while extending in the same direction as the conveyance direction of the substrate. Plurality of angled channels laterally channel fluid and particles toward opposite axial ends of the roller as shown by arrows 25. The embodiment shown in FIG. 5D can be used in conjunction with the embodiment shown in FIG. 5C.

Embodiments disclosed herein can provide for improved performance with respect to removal of particles from a substrate surface while simultaneously maintaining high quality substrate surfaces, such as glass substrate surfaces, that are substantially free of undesirable scratch, stain, and surface loss effects. For example, embodiments disclosed herein can provide for improved performance with respect to removal of relatively large (greater than 5 micron), medium (1-5 micron), and small (0.3 to 1 micron) particles in high resolution application as well as relatively large (greater than 5 micron), medium (3-5 micron), and small (1 to 3 micron) particles in low resolution application. In that regard, embodiments disclosed herein can, upon application to glass substrates, result in substrate surfaces with relatively low overall residual particle densities, such as overall low resolution particle densities of less than 0.004 pcs/cm² and overall high resolution particle densities of less than 0.065 pcs/cm².

In addition, embodiments disclosed herein can provide for significantly greater removal of medium and small particles (e.g., particles with sizes of less than 5 microns) than alternative roller technologies. For example, embodiments disclosed herein can provide for particle removal such that at least a 50%, further such as at least a 70%, and yet further such as at least a 80%, including from a 50% to 95%, and further including from a 75% to 90% reduction of residual particles with sizes of less than 5 microns (such as particles with sizes of from 0.3 to 5 microns) results following application as compared to an alternative roller technology. A reduction of 80% residual particles following application means than only 20% as many particles remain on the substrate (e.g., 20% particle density) following at least one embodiment disclosed herein as compared to an alternative roller technology and a reduction of 95% residual particles following application means that only 5% as many particles remain on the substrate (e.g., 5% particle density) following at least one embodiment disclosed herein as compared to an alternate roller technology.

Embodiments disclosed herein can also provide superior particle removal while maintaining high quality substrate surfaces with respect to scratch, stain, and surface loss characteristics. For example, when the substrate surface is a glass surface, embodiments disclosed herein can provide superior particle removal while maintaining surfaces that have less than 0.05% surface loss, such than less than 0.045% surface loss, less than 0.005%, such than less than 0.0045% surface scratch, and less than 0.0016% surface stain.

It will be apparent to those skilled in the art that various modifications and variations can be made to the embodiments of the present disclosure without departing from the spirit and scope of the disclosure. Thus, it is intended that the present disclosure cover the modifications and variations of these and other embodiments provided they come within the scope of the appended claims and their equivalents.

What is claimed is:

1. A method for cleaning at least one edge of a substrate, the method comprising conveying the at least one substrate edge across a cleaning system comprising:
at least one nozzle configured to deliver at least one cleaning fluid to at least one edge of the substrate; and
at least one roller comprising a plurality of angled channels on the outer surface of the roller, wherein the plurality of angled channels are configured to laterally channel fluid and particles toward opposite axial ends of the roller;
wherein the substrate comprises a first surface and a second surface that is substantially parallel to the first surface and the at least one roller is configured to contact at least one of the first surface and the second surface.

2. The method according to claim 1, wherein the method comprises cleaning the first surface and the second surface of the substrate, the at least one nozzle is configured to deliver at least one cleaning fluid to each of the first and second surfaces of the substrate, and the at least one roller is configured to contact each of the first and second surfaces of the substrate.

3. The method according to claim 1, wherein the at least one roller contacts a first surface of the substrate at a point where the conveyance direction of the substrate is the same as a rotational direction of the at least one roller.

4. The method according to claim 3, wherein the at least one roller contacts a second surface of the substrate at a point where the conveyance direction of the substrate is the opposite of the rotational direction of the at least one roller.

5. The method according to claim 3, wherein the at least one roller contacts a first surface of the substrate at a point where the plurality of angled channels on the outer surface of the at least one roller extend toward opposite axial ends of the roller while extending in the opposite direction as the conveyance direction of the substrate.

6. The method according to claim 5, wherein the at least one roller contacts a second surface of the substrate at a point where the plurality of angled channels on the outer surface of the at least one roller extend toward opposite axial ends of the roller while extending in the same direction as the conveyance direction of the substrate and the at least one roller contacts a second surface of the substrate at a point where the conveyance direction of the substrate is the opposite of the rotational direction of the at least one roller.

7. The method according to claim 1, wherein the substrate comprises glass.

8. The method according to claim 1, wherein the roller comprises at least one sponge or sponge-like material that comprises at least one material selected from the group consisting of polyvinyl acetate, polyvinyl alcohol, nylon, urethane, and mohair.

9. The method according to claim 1, wherein the plurality of angled channels are mirror images of each other on either side of the at least one roller in the axial direction, wherein the channels are substantially parallel to each other between the midpoint and each axial end of the roller, and are each angled relative to their mirror at a mirror angle of from 60 to 120 degrees.

10. The method according to claim 1, wherein the plurality of angled channels each have a depth of from 2 to 20 percent of the radius of the body of the at least one roller and a width of from 1 to 10 percent of the circumference of the body of the at least one roller.

11. An apparatus for cleaning at least one edge of a substrate, the apparatus configured to convey the at least one substrate edge across a cleaning system comprising:
at least one nozzle configured to deliver at least one cleaning fluid to at least one edge of the substrate; and
at least one roller comprising a plurality of angled channels on the outer surface of the roller, wherein the plurality of angled channels are configured to laterally channel fluid and particles toward opposite axial ends of the roller;
wherein the substrate comprises a first surface and a second surface that is substantially parallel to the first surface and the at least one roller is configured to contact at least one of the first surface and the second surface.

12. The apparatus according to claim 11, wherein the apparatus is configured to clean the first surface and the second surface of the substrate, the at least one nozzle is configured to deliver at least one cleaning fluid to each of the first and second surfaces of the substrate, and the at least one roller is configured to contact each of the first and second surfaces of the substrate.

13. The apparatus according to claim 11, wherein the at least one roller is configured to contact a first surface of the substrate at a point where the conveyance direction of the substrate is the same as a rotational direction of the at least one roller.

14. The apparatus according to claim 11, wherein the at least one roller is configured to contact a second surface of the substrate at a point where the conveyance direction of the substrate is the opposite of the rotational direction of the at least one roller.

15. The apparatus according to claim 11, wherein the at least one roller is configured to contact a first surface of the substrate at a point where the plurality of angled channels on the outer surface of the at least one roller extend toward opposite axial ends of the roller while extending in the opposite direction as the conveyance direction of the substrate.

16. The apparatus according to claim 15, wherein the at least one roller is configured to contact a second surface of the substrate at a point where the plurality of angled channels on the outer surface of the at least one roller extend toward opposite axial ends of the roller while extending in the same direction as the conveyance direction of the substrate and the at least one roller is configured to contact a second surface of the substrate at a point where the conveyance direction of the substrate is the opposite of the rotational direction of the at least one roller.

17. The apparatus according to claim 11, wherein the substrate comprises glass.

18. The apparatus according to claim 11, wherein the roller comprises at least one sponge or sponge-like material that comprises at least one material selected from the group consisting of polyvinyl acetate, polyvinyl alcohol, nylon, urethane, and mohair.

19. The apparatus according to claim 11, wherein the plurality of angled channels are mirror images of each other on either side of the at least one roller in the axial direction, wherein the channels are substantially parallel to each other between the midpoint and each axial end of the roller, and are each angled relative to their mirror at a mirror angle of from 60 to 120 degrees.

20. The apparatus according to claim 11, wherein the plurality of angled channels each have a depth of from 2 to 20 percent of the radius of the body of the at least one roller and a width of from 1 to 10 percent of the circumference of the body of the at least one roller.
